(19) United States
(12) Patent Application Publication
(10) Pub. No.: US 2025/0178050 A1
(43) Pub. Date: Jun. 5, 2025

(54) IN-SITU ELECTRIC STRATIFIED REMEDIATION DEVICE AND METHOD FOR ACCURATE POSITION IN REMEDIATION DEPTH IN SEDIMENT

(71) Applicant: CHANGJIANG RIVER SCIENTIFIC RESEARCH INSTITUTE, Wuhan, Hubei (CN)

(72) Inventors: Xianqiang TANG, Wuhan, Hubei (CN); Yanping HU, Wuhan, Hubei (CN); Rui LI, Wuhan, Hubei (CN); Zhenhua WANG, Wuhan, Hubei (CN)

(73) Assignee: CHANGJIANG RIVER SCIENTIFIC RESEARCH INSTITUTE, Wuhan, Hubei (CN)

(21) Appl. No.: 18/574,955

(22) PCT Filed: Aug. 24, 2023
(86) PCT No.: PCT/CN2023/114572

§ 371 Date: Dec. 28, 2023

(30) Foreign Application Priority Data
Aug. 24, 2022 (CN) 202211016453.4

(51) Int. Cl. B09C 1/08

(52) U.S. Cl. CPC B09C 1/085; B09C 2101/00

(57) ABSTRACT

The present disclosure provides an in-situ electric stratified remediation device and method for accurate position in remediation depth in sediment. the device includes a telescopic rod, a porous cylinder, a water storage tank, a curing agent storage device, and a depth determining module. The water storage tank is configured to collect sediment pore water and contaminants converged along a surface groove of a columnar electrode; and the fixed determining module is configured to send an indication information in response to that the curing agent storage device is inserted below a mud-water interface, while triggering release of curing agent from a wall of the curing agent shroud.

### CROSS-REFERENCE TO RELATED APPLICATIONS

This application claims priority to Chinese Patent Application No. 202211016453.4, filed with the Chinese Patent Office on Aug. 24, 2022, the entire content of which is incorporated herein by reference.

### TECHNICAL FIELD

The present application relates to the field of environment treatment, and more particularly, to an in-situ electric stratified remediation device and method for accurate position in remediation depth in sediment.

### BACKGROUND

Most of the pollutants in industrial and agricultural wastewater and domestic sewage enter the river and lake through sewage discharge, rainwater scouring and the like, resulted in polluting the river and lake. As an important role for the river and lake ecology, in case of long-term serious pollution on water quality, the sediment has become a carrier for the water pollution, and has become an endogenous source of the pollution with changed water environment. The complete removal of sediment pollutants in the river and lake has been found as an important means for effective treatment on polluted water in the river and lake. The results show that the vertical distribution of pollutants and concentrations of sediment changes in different rivers and lakes, and different zones. Therefore, in order to reduce the treatment amount of polluted sediment, the sediment not only need be treated in zones, but also need be treated in layers.

Currently, for the treatment on the polluted sediment, sediment dredging technology is commonly used. However, it is difficult to popularize on a large scale due to inaccurate, large work quantity and great disturbance to water. Common in-situ control technologies, such as in-situ cover and in-situ passivation, can inhibit the spread contaminants at the sludge-water interface by means of adsorption, passivation, and the like. However, the contaminants cannot be completely removed, the technical means is relatively passive, and there is a risk of increasing the sediment deposition thickness. As a new type of in-situ remediation technology, the electric remediation technology assembles a EKG electrode plate with both water conductivity and conductivity into a specific device, as such, in-situ removal of pollutants in a drainage process can be realized, which has the characteristics of short period and high efficiency, and is particularly suitable for the sediment with low permeability. However, similar technical equipment currently focuses mainly on the ex-situ treatment of the dredged sediment in the river and lake (Chinses application Ser. No. 201810319167.2) or in the treatment of the sediment in the river and lake without being overlaid above with water (Chinses application Ser. No. 202010564281.9). There are few reports of in-situ remediation of the polluted sediment in the river and lake overlaid above with water. Chinese Utility Model patent application Ser. No. 201721571187.6, filed earlier by the inventor Tang Xiangqiang and titled with “IN-SITU DRAINAGE DEVICE FOR POLLUTED SEDIMENT IN RIVER AND LAKE BASED ON DRAINAGE CONDUCTED BY PORE”, discloses an in-situ electrodynamic remediation plate-like device for polluted sediment in the river and lake contaminants. The device is provided with a rigid plexiglass cover at upper end of a pole plate conducting water. The device is inserted into the sediment together with the plexiglass cover to stand in close proximity to the sediment, and then electrodynamic drainage is started to remove the sediment contaminants. The device can be temporarily isolated from the overlying water to remove the sediment contaminants in-situ electromechanically. However, t the device cannot be accurately positioned in a certain depth in the sediment, that is, the stratified treatment on the polluted sediment cannot be realized.

For the stratified treatment on the sediment, the water depth of the zone to be treated is first determined, and then the device is inserted to a specified depth of the sediment based on the water depth. Currently, the water depth measuring instrument is mainly used for measuring the ocean depth, of which the measuring accuracy is affected by factors such as ship swinging, wave, water temperature, water quality, accuracy and stability of the instrument, and the error from the instrument is about ±10 cm. There is still a need in determining the depth of shallow water lake to assist in accurate positioning the device in a specified depth in the sediment. In a case that the sediment is uneven or has benthic plants, the difficult on accurately positioning the device in the sediment is further increased, and the field operation and applicability are poor, and the cost and workload are high.

As above, for the in-situ treatment on the polluted sediment in the river and lake with overlying water, the way that the electric remediation device is positioned at a specified depth in the sediment to be stratified treated has not been reported. However, the accurate position of the device is difficult, the field operation is complex, the applicability is poor, and the cost is high, in combination with the water depth measuring instrument. Therefore, there is an urgent need to develop a device which is simple to operate, strong in applicability, low in cost, capable of accurate position the depth in the sediment, and capable of achieving stratified treatment on polluted sediment under electric remediation.

### SUMMARY

In view of the above problems, the present application provides an in-situ electric stratified remediation device for accurate position in remediation depth in sediment and an in-situ electric stratified remediation method therefor. The present application employs a columnar electric remediation device to reduce the difficulty of sediment disturbance and insertion of the device into the sediment, while greatly reducing the risk of phosphorus release from the sediment to the water. In addition, the device ingeniously incorporates a depth determining module, wherein the positioning slider contacts the sediment, and the positioning slider moves upwards to touch the switch button to release the floating ball. As such, the device is positioned to insert into the mud-water interface, and then the device is further inserted to a specified depth below the mud-water interface based on adjusting the scale on the telescopic rod, and finally the contaminants in the sediment at the specified depth is released with drained water under the action of an electric field. The above device and the method implemented with the device is not affected by the turbid water, and does not need to accurately determine the water depth of each point in the treatment zone by using the depth measuring instrument in advance, so that the accurate position on the depth of the device inserted into the sediment can be realized, and the stratified in-situ treatment of the polluted sediment in the river and the lake can be realized.

To achieve the above object, the present application adopts the following technical solutions.

According to a first aspect, an embodiment of the present application provides an in-situ electric stratified remediation device for accurate position in remediation depth in sediment, and the device includes a telescopic rod, a porous cylinder, a water storage tank, a curing agent storage device, and a depth determining module. The curing agent storage device is mounted on at the top of the porous cylinder, and the curing agent storage device is connected to the bottom of the telescopic rod. The water storage tank is disposed at the bottom of the porous cylinder and is in communication with the porous cylinder. A columnar electrode is embedded in the porous cylinder and is connected to a power source. A permeable mudguard cloth is covered on the porous cylinder. The water storage tank is configured to collect the contaminants enriched in the vicinity of the device and converged along a surface groove of the columnar electrode along with the sediment pore water. The depth determining module is configured to send indication information in response to that the curing agent storage device is just inserted below the mud-water interface, as such, the device is inserted to a specified depth below the mud-water interface by the telescopic rod, while the depth determining module triggers release of the curing agent from the periphery of the curing agent shroud to fill a gap between the surface of the device and the sediment. According to a second aspect, embodiments of the present application provides an in-situ electric stratified remediation method for accurate position in remediation depth in sediment, which is performed using the above-described device. The method includes the following steps:

(1) constructing a depth determining module matched with the in-situ electric stratified remediation device;

(2) filling a curing agent into a curing agent buffer tank and a curing agent shroud of the in-situ electric stratified remediation device;

(3) inserting a fixing column with a vertically freely slide and horizontally freely telescopic switch button-type sleeve in advance, wherein the switch button-type sleeve is sleeved on a handle of a telescopic rod to serve as a fixing member between the fixing column and the telescopic rod to ensure vertical insertion of the in-situ electric stratified remediation device into the sediment;

(4) defining a horizontal plane disposed with an upper edge of the curing agent shroud as a mud-water interface, providing indication information from the depth determining module in response to that the curing agent storage device is just inserted below the mud-water interface, and then inserting the device to a specified depth below the mud-water interface through the telescopic rod, while triggering the depth determining module to releasing the curing agent from the periphery of the curing agent shroud to fill the gap between the surface of the device and the sediment;

(5) turning on a power supply connected to the columnar electrode, wherein metal ions, kation as H⁺ and NH⁴⁺, and anions such as PO₄³⁻, HPO₄²⁻, NO₃⁻, and OH⁻ in the sediment are migrated to a cathode and a anode under action of an electric field, respectively, and are migrated to the cathode with the pore water under action of electroosmosis; wherein he sediment pollutants are collected to vicinity of the columnar electrode in situ and efficiently under action of electromigration and electroosmosis;

(6) converging contaminants enriched in the vicinity of the columnar device to the water storage tank along a surface groove of the columnar electrode with the sediment pore water; and

(7) discharging the sediment pore water the collected by the water storage tank regularly by a pump, to realize in-situ and complete separation of pollutants from the sediment in a specified remediation layer.

### Beneficial Effect

With the above technical solution, the present application has the following beneficial effect:

(1) The depth determining module is provided on the in-situ electric remediation device. As the device is inserted into a mud-water interface and positioned, the depth determining module provides indication information by using a floating ball floating out of water, an indicator light, an alarm sound, or the like. The telescopic rod having a scale in the module is used to position a depth of the device in the sediment accurately. The above is simple to operate, strong in applicability and low in cost, is not affected by the turbid water, and does not need to accurately measure the water depth of each point in the treatment zone by using a depth measuring instrument in advance.

(2) With the depth determining module providing to the column electric remediation device, the positioning slide in the module serves as a sealing cover for the curing agent shroud prior to inserting the device into the sediment, to avoid the curing agent from flowing out of the shroud to storage the curing agent. As the device is inserted into the sediment, the positioning slide movers upwards to release the curing agent stored in the shroud, to file the gap between the surface of the device and the sediment, to isolate the device from the overlapping water and realize stratified treatment and remediation on the sediment in layers.

### BRIEF DESCRIPTION OF THE DRAWINGS

FIG. 1 is a schematic structural diagram of an in-situ electric stratified remediation device for accurate position in remediation depth in sediment according to the present application;

FIG. 2 is a cross-sectional view of FIG. 1; and

FIG. 3 is an enlarged view of an attachment structure of a positioning slide to a fixing rope and a floating ball of FIG. 1.

Reference numerals: 1—telescopic rod, 2—exhaust pipe, 3—drain pipe, 4—waterproof wire, 5—curing agent injection port, 6—curing agent buffer tank, 7—conical deflector, 8—curing agent shroud, 9—water-permeable mudguard cloth, 10—porous cylinder, 11—columnar electrode, 12—water storage tank, 13—positioning slide, 14—switch button, 15—fixing rope, 16—floating ball, and 17—telescopic rope.

### DETAILED DESCRIPTION OF THE EMBODIMENTS

In order that the objects, technical solutions, and advantages of the embodiments of the present application may be made clearer, the technical solutions in the embodiments of the present application will be clearly and completely described with reference to the accompanying drawings of the embodiments of the present application. It should be understood that the described embodiments are some, but not all embodiments of the present application. Based on the embodiments in the present application, all other embodiments obtained by a person of ordinary skill in the art without involving any inventive effort fall in the scope of the present application.

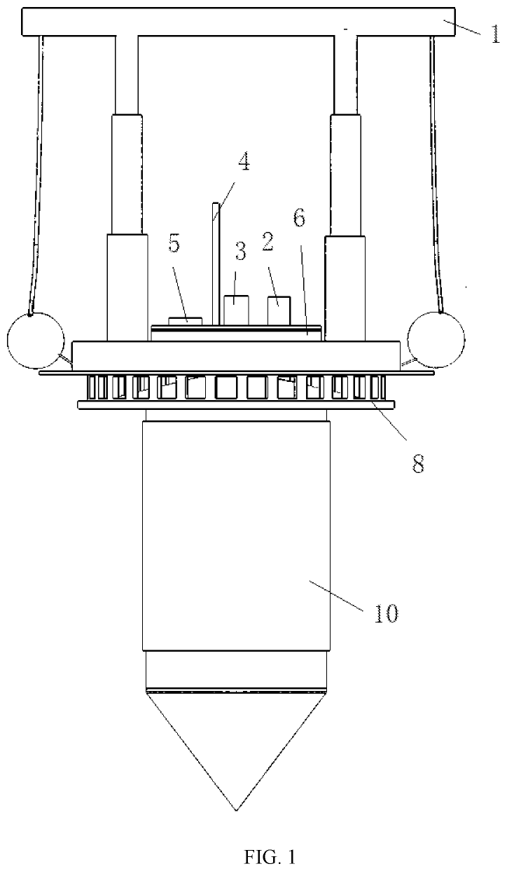

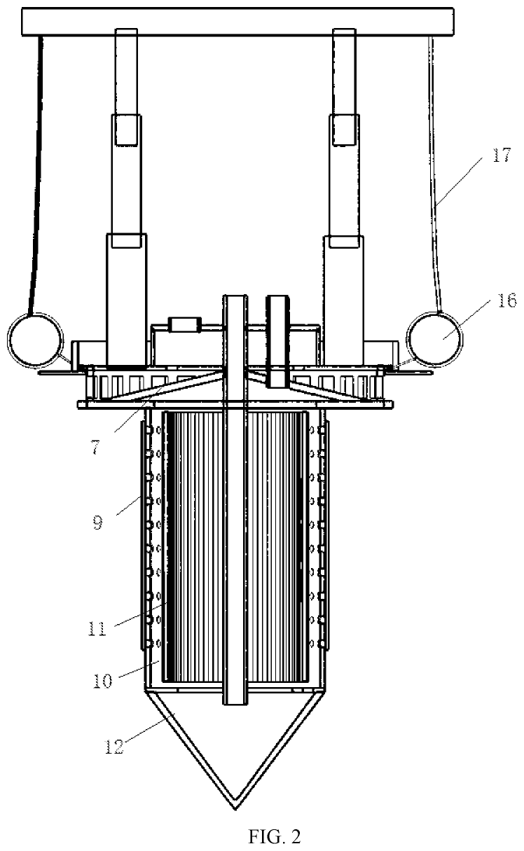

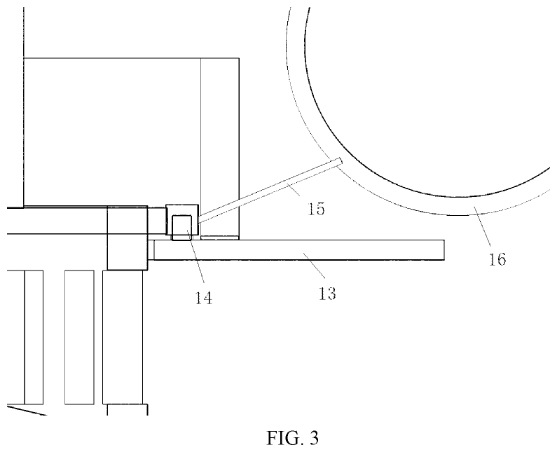

Referring to FIG. 1 to FIG. 3, an embodiment of the present application provides a columnar electric remediation device for accurate position in remediation depth in sediment, which is subject to treatment and remediation on sediment in a phosphorus-polluted lake. The device comprises a telescopic rod 1, a porous cylinder 10, a water storage tank 12, a curing agent storage device, and depth determining module. The curing agent storage device is mounted at top of the porous cylinder 10, the bottom of the telescopic rod 1 is connected to the curing agent storage device, and the water storage tank 12 is disposed on at bottom of the porous cylinder 10 and is communicated with the porous cylinder 10.

The depth determining module includes a positioning slide 13, a switch button 14, a floating ball 16, a fixing rope 15, and a telescopic rope 17. The positioning slide 13 is slidably sleeved on periphery of a curing agent shroud 8. The switch button 14 is mounted on an upper edge of the curing agent shroud 8. The fixing rope 15 connects the switch button 14 and the floating ball 16. The telescopic rope 17 is connected to the floating ball 16 to place the floating ball 16 in a handle of the telescopic rod 1.

In response to that the curing agent storage device is just inserted below the mud-water interface, the depth determining module is configured to lead the positioning slide 13 to touch the switch button 14 to mark, such as, a floating ball, an indicator lamp, an alarm and the like. The positioning slide 13 can release the curing agent stored in the curing agent storage device to fill a gap between the surface of the device and the sediment during contact and upward movement of the positioning slide 13.

The curing agent storage device includes a curing agent buffer tank 6, a curing agent shroud 8 communicating with the curing agent buffer tank 6, and a conical deflector 7 embodied in the curing agent shroud 8. A plurality of openings is provided around the periphery of the curing agent shroud 8, and the openings are shielded by the positioning slide 13. In response to that the positioning slide 13 moves upward, the openings around the periphery of the curing agent shroud 8 are exposed, and the curing agent can be released from the periphery of the curing agent shroud 8.

A columnar electrode 11 is embedded in the porous cylinder 10, and a water-permeable mudguard cloth 9 is coated on the porous cylinder 10.

The present application is designed on the basis of a columnar electric remediation device, and ingeniously incorporates a depth determining module. With the positioning slide 13 arranged on the periphery of the curing agent shroud 8 contacting the mud-water interface, the device slides upwards to touch the switch button 14 at the upper edge of the curing agent shroud 8 and releases a fixing rope 15 connected to a floating ball 16, and the floating ball 16 floats out of the water surface under the buoyancy force and the tension force from the telescopic rope 17 to mark that the curing agent shroud 8 is just inserted under the mud-water interface. Alternatively, the alarm or indicator light connected to the switch button 14 and mounted on the handle of the telescopic rod 1 is triggered to indicate that the curing agent shroud 8 is just inserted under the mud-water interface. Then the device is inserted into a specified depth under the mud-water interface by taking the telescopic rod 1 as a measuring tool to notice the scale thereon. At the same time, the curing agent can be released from the periphery of the curing agent shroud 8 to fill the gaps between the surface of the device and the sediment, during the movement of the positioning slide 13 to the sediment. Heretofore, the device of the present application is isolated from the overlying water in the sediment, and is accurately positioned in the sediment. Thus, in-situ treatment in zones on the sediment with different depths in the river and lake is realized. The method provided by the device according to the present application is not affected by the turbid water, and does not need to accurately determine the water depth of each point in the treatment zone by using a water depth measuring instrument in advance, and has the characteristics of simple operation, strong applicability and the like.

As shown in FIG. 1, in an example in which a level of a floating ball indicating that the device is positioned at a mud-water interface, the present application applies a columnar electric remediation device for accurate position in remediation depth in sediment to remediate the phosphorus-polluted sediment. The method for accurate position in remediation depth in sediment to remediate the phosphorus-polluted sediment is as follows.

(1) As the zone to be treated or remediated is selected, it is determined that the depth of the overlying water is 3 m, the remediation depth in the sediment is 20 cm or less under the mud-water interface, and the thickness of the sediment remediation layer is 30 cm.

(2) The curing agent is filled with the curing agent buffer tank 6 and the curing agent shroud 8 through the curing agent injection port 5.

(3) According to the water depth, a fixing column is vertically inserted, and the fixing column is provided with a vertically freely slide and horizontally freely telescopic switch button-type sleeve which is sleeved on the handle of the telescopic rod. The switch button-type sleeve serves as a fixing member between the fixing column and the telescopic rod 1, to ensure that the electric remediation device is vertically inserted into the sediment. Then, the columnar electrode 11 is connected with the waterproof wire 4 of 4 m in length, and the exhaust pipe 2 and the drain pipe 3 on the curing agent buffer tank 6 are connected by the wire of 4 m in length. An end of the drain pipe 3 extends into the bottom of the water storage tank 12, and the other end of the drain pipe 3 is provided in communication with the pump. The pump in communication with the drain pipe 3 is periodically opened to discharge the sediment collected by the water storage tank 12 through the pore. An end of the exhaust pipe 2 is located at the top of the water storage tank 12, and the other end of the exhaust pipe 2 extends out of the overlapping water above the sediment to discharge the gas generated by the electrolysis in time.

(4) The telescopic rod 1 of the assembled columnar electric remediation device is sleeved on the fixing column by the switch button-type sleeve, and then the device is vertically put into the water along the fixing column. With the columnar electric remediation device contacting the sediment, the columnar electric remediation device is slowly inserted into the sediment by the telescopic rod 1. After the positioning slide 13 slides upwards to touch the switch button 14 at the top of the curing agent shroud 8 and releases the floating ball 16, the floating ball 16 rapidly floats out of the water surface under the buoyancy force and the tension of the telescopic rope 17. Thus, the upper side of the curing agent shroud 8 of the columnar electric remediation device is positioned at the mud-water interface.

(5) According to the scale on the telescopic rod 1, and referring to liquid level of the overlapping water above as a reference surface, the device is continuously inserted downward by the telescopic rod 1 by 20 cm. Thus, accurate position in the polluted sediment can be realized with a layer thickness of 30 cm and 20 cm below the mud-water interface.

The columnar devices may be arranged in a regular hexagonal configuration. The device in the middle of the positive hexagonal configuration is connected to a negative electrode of DC regulated power supply (the columnar electrode 11 is a cathode). The six devices around the middle of the regular hexagonal configuration are connected to a positive electrode of the power supply (the columnar electrode 11 is an anode). The distance between the two adjacent devices is 1.0 m.

(6) During the upward sliding movement of the positioning slide 13, the curing agent flows out from the opening around the periphery of the curing agent shroud 8 to fill the gap between the sediment and on the surface of the device.

(7) With the DC regulated power supply being turned on, the metal ions, kation as H⁺, and anions such as PO₄³⁻, HPO₄²⁻, and OH⁻ in the sediment are migrated to the cathode and the anode under the action of an electric field, respectively, and are migrated to the cathode (the center of the regular hexagon) with the pore water under the action of electroosmosis. The sediment pollutants are collected to the vicinity of the columnar electrode in situ and efficiently under the action of electromigration and electroosmosis.

(8) The pollutants, such as phosphorus, which migrate to the vicinity of the columnar electric remediation device, pass through the water-permeable mudguard cloth 9, the porous cylinder 10, and the columnar electrode 11 in sequence with the sediment pore water, and finally pass into the water storage tank 12 along the surface grooves of the columnar electrode 11.

(9) The pump in communication with the drain pipe 3 is periodically opened to discharge the sediment pore water of the sediment collected by the water storage tank 12, so that the phosphorus is separated from the sediment of the specified remediated sediment in situ and completely.

The above description is merely for embodiments of the present application, but the scope of the protection of the present application is not limited thereto. Any variations or substitutions readily conceivable by a person skilled in the art in the technical scope disclosed in the present application shall be constructed as falling in the scope of the protection of the present application. Therefore, the scope of the protection of the present application should be subject to the scope of the protection of the claims.

1. An in-situ electric stratified remediation device for accurate position in remediation depth in sediment, comprising a telescopic rod, a porous cylinder, a water storage tank, a curing agent storage device, and a depth determining module; wherein the curing agent storage device is mounted at top of the porous cylinder and is connected to a bottom of the telescopic rod, and the water storage tank is disposed at bottom of the porous cylinder and is communicated with the porous cylinder; wherein the porous cylinder is embedded with a columnar electrode connected to a power source, and a permeable mudguard cloth is covered on the porous cylinder; wherein the water storage tank is configured to collect contaminants enriched in vicinity of the device and converged along a surface groove of the columnar electrode along with sediment pore; and the depth determining module is configured to send indication information in response to that the curing agent storage device is just inserted below a mud-water interface, so that the device is inserted to a specified depth below the mud-water interface by the telescopic rod, while the depth determining module triggers release of the curing agent from a curing agent shroud to fill a gap between a surface of the device and the sediment.

2. The in-situ electric stratified remediation device for accurate position in remediation depth in sediment of claim 1, wherein the curing agent storage device comprises a curing agent buffer tank, the curing agent shroud communicated with the curing agent buffer tank, and a conical deflector embedded in the curing agent shroud, wherein a plurality of openings is provided around a wall of the curing agent shroud.

3. The in-situ electric stratified remediation device for accurate position in remediation depth in sediment of claim 2, wherein the depth determining module comprises a positioning slide slidably sleeved on a periphery of the curing agent shroud, a switch button mounted on an upper edge of the curing agent shroud, and an indication device associated with the switch button; wherein the positioning slide sleeved on the periphery of the curing agent shroud contacts the mud-water interface and slides upward to touch the switch button mounted on the upper edge of the curing agent shroud, and the switch button triggers the indication device to send an indication information to mark the curing agent shroud just below the mud-water interface; wherein the plurality of openings around the around the wall of the curing agent shroud is initially blocked by the positioning slide and is exposed with the positioning slide sliding upward, and the curing agent is released from the wall of the curing agent shroud.

4. The in-situ electric stratified remediation device for accurate position in remediation depth in sediment of claim 3, wherein the indication device comprises a floating ball, a fixing rope connecting the switch button and the floating ball, and a telescopic rope connecting the floating ball and placed in a handle of the telescopic rod; wherein as the curing agent storage device is just inserted below the mud-water interface, the fixing rope connecting the floating ball is released to lead the floating ball float out of water under a buoyancy force and a tension of the telescopic rope as the indication information to mark the curing agent shroud just inserted below the mud-water interface, in response to that the positioning slide cover sleeved on the periphery of the curing agent shroud contacts the mud-water interface and slides upwards to touch the switch button mounted on the upper edge of the curing agent shroud.

5. The in-situ electric stratified remediation device for accurate position in remediation depth in sediment of claim 3, wherein the indication device includes an acousto-optic alarm circuit in communication with the switch button, and the acousto-optic alarm circuit is mounted at a handle of the telescopic rod; wherein as the curing agent storage device is just inserted below the mud-water interface, the switch button triggers the acousto-optic alarm circuit to send an acousto-optic alarm signal as the indication information to mark the curing agent shroud just inserted below the mud-water interface, in response to that the positioning slide cover sleeved on the periphery of the curing agent shroud contacts the mud-water interface and slides upwards to touch the switch button mounted on the upper edge of the curing agent shroud.

6. The in-situ electric stratified remediation device for accurate position in remediation depth in sediment of claim 2, wherein the curing agent buffer tank is provided with a curing agent injection port, and the curing agent injection port is configured to inject curing agent into the curing agent buffer tank and the curing agent shroud.

7. The in-situ electric stratified remediation device for accurate position in remediation depth in sediment of claim 2, wherein the curing agent buffer tank is provided with an exhaust pipe and a drain pipe, an end of the drain pipe extends into bottom of the water storage tank, another end of the drain pipe is communicated with a pump, and the pump communicated with the drain pipe is configured to periodically open to discharge sediment pore water collected by the water storage tank; wherein an end of the exhaust pipe is disposed at top of the water storage tank, another end of the exhaust pipe extends out of overlapping water above the sediment, and the exhaust pipe is configured to discharge gas generated by electrolysis in time.

8. An in-situ electric stratified remediation method for accurate position in remediation depth in sediment, wherein the method is carried out by using the device of claim 1, and the method comprises:
(1) constructing the depth determining module matched with the device;
(2) filling a curing agent into a curing agent buffer tank and a curing agent shroud of the device;
(3) inserting a fixing column with a vertically freely slide and horizontally freely telescopic switch button-type sleeve in advance, wherein the switch button-type sleeve is sleeved on a handle of the telescopic rod to serve as a fixing member between the fixing column and the telescopic rod to ensure vertical insertion of the device into the sediment;
(4) defining a horizontal plane disposed with an upper edge of the curing agent shroud as the mud-water interface, providing indication information from the depth determining module in response to that the curing agent storage device is just inserted below the mud-water interface, and then inserting the device to a specified depth below the mud-water interface through the telescopic rod, while triggering the depth determining module to releasing the curing agent from the periphery of the curing agent shroud to fill the gap between the surface of the device and the sediment;
(5) turning on a power supply connected to a columnar electrode, wherein metal ions, kation as H⁺ and NH⁴⁺, and anions as PO₄³⁻, HPO₄²⁻, NO₃⁻, and OH⁻ in the sediment are migrated to a cathode and an anode under action of an electric field, respectively, and are migrated to the cathode with pore water under action of electroosmosis; wherein he sediment pollutants are collected to vicinity of the columnar electrode in situ and efficiently under action of electromigration and electroosmosis;
(6) converging contaminants enriched in the vicinity of the columnar device to the water storage tank along surface grooves of the columnar electrode with sediment pore water; and
(7) discharging the sediment pore water the collected by the water storage tank regularly by a pump, to realize in-situ and complete separation of pollutants from the sediment in a specified remediation layer.

9. The in-situ electric stratified remediation method for accurate position in remediation depth in sediment of claim 8, wherein the depth determining module sends indication information in response to that the curing agent storage device is just inserted below the mud-water interface, comprises that: the depth determining module comprises a positioning slide slidably sleeved on a periphery of the curing agent shroud, a switch button mounted on an upper edge of the curing agent shroud, and an indication device associated with the switch button; the indication device comprises a floating ball, a fixing rope connecting the switch button and the floating ball, and a telescopic rope connecting the floating ball and placed in a handle of the telescopic rod; as the curing agent storage device is just inserted below the mud-water interface, the fixing rope connecting the floating ball is released to lead the floating ball float out of water under a buoyancy force and a tension of the telescopic rope as the indication information to mark the curing agent shroud just inserted below the mud-water interface, in response to that the positioning slide cover sleeved on the periphery of the curing agent shroud contacts the mud-water interface and slides upwards to touch the switch button mounted on the upper edge of the curing agent shroud.

10. The in-situ electric stratified remediation method for accurate position in remediation depth in sediment of claim 8, wherein the depth determining module sends indication information in response to that the curing agent storage device is just inserted below the mud-water interface, comprises that: the depth determining module comprises a positioning slide slidably sleeved on a periphery of the curing agent shroud, a switch button mounted on an upper edge of the curing agent shroud, and an indication device associated with the switch button; the indication device includes an acousto-optic alarm circuit in communication with the switch button, and the acousto-optic alarm circuit is mounted at a handle of the telescopic rod; wherein as the curing agent storage device is just inserted below the mud-water interface, the switch button triggers the acousto-optic alarm circuit to send an acousto-optic alarm signal as the indication information to mark the curing agent shroud just inserted below the mud-water interface, in response to that the positioning slide cover sleeved on the periphery of the curing agent shroud contacts the mud-water interface and slides upwards to touch the switch button mounted on the upper edge of the curing agent shroud.
